(19) United States
(12) Patent Application Publication
(10) Pub. No.: US 2024/0220256 A1
(43) Pub. Date: Jul. 4, 2024

(54) POLYMORPHIC TWO-DIMENSIONAL REGISTER FILE

(71) Applicant: Meta Platforms Technologies, LLC, Menlo Park, CA (US)

(72) Inventors: Reza Tusi, San Jose, CA (US); Tomonari Tohara, Sunnyvale, CA (US); Vignesh Vivekraja, Santa Clara, CA (US); Javid Jaffari, San Diego, CA (US)

(21) Appl. No.: 18/525,217

(22) Filed: Nov. 30, 2023

Related U.S. Application Data
(60) Provisional application No. 63/477,535, filed on Dec. 28, 2022.

(51) Int. Cl. G06F 9/30; G06F 9/38

(52) U.S. Cl. CPC G06F 9/3013; G06F 9/3887

(57) ABSTRACT

In one embodiment, a computing system may load data from a memory unit into a number of registers according to a first order by which the data is arranged. The registers may be configured to be accessed during a single operation cycle. The system may determine a second order for the data based on one or more subsequent operations to process the data. The system may read the data from the registers according to the second order during one or more operation cycles. The data read from the registers may be arranged in the second order. The system may transmit the data arranged in the second order to an execution unit configured to execute the one or more subsequent operations to process the data arranged in the second order.

### PRIORITY

This application claims the benefit under 35 U.S.C. § 119(e) of U.S. Provisional Patent Application No. 63/477,535, filed 28 Dec. 2022, which is incorporated herein by reference.

### TECHNICAL FIELD

This disclosure generally relates to computer technology, in particular to register file design in processors.

### BACKGROUND

A computer can be programmed to carry out sequences of arithmetic operation or logical operations automatically. Modern computers can perform generic programs. These programs enable computers to perform a wide range of tasks using processors, memories, and register files.

A register file is an array of processor registers in a central processing unit (CPU). Register banking uses a single name to access multiple different physical registers depending on the operating mode. Modern integrated circuit-based register files are usually implemented by way of fast static RAMs having read and write ports. CPUs usually have a set of registers which are used to stage data between memory and the functional units on the chip.

### SUMMARY OF PARTICULAR EMBODIMENTS

Particular embodiments described herein relate to systems and methods of using a two-dimensional (2D) ploy-morphic register file (PRF) to transform data by accessing the 2D PRF in particular order. The 2D PRF may provide access in two dimensions (instead of the traditional 1D register file that can only be accessed row-by-row or column-by-column) and may have varying bit-width element support for variously data types. Traditional CPUs or DSPs may have memory architectures that are weak on two-dimensional (2D) matrix handling, such as transposing, mirroring, rotating, inserting, and/or removing on matrices. CPU and Vector/SIMD (Single Instruction, Multiple Data) DSPs are good at accessing data in consecutive addressing order. For example, to perform computation on a transposed form of a 2D matrix, which is stored in row-major, the CPU or DSP either has to load them in column major through many single element (scalar) accesses or load them in vectors into vector registers (in vector/SIMD machines) and transform them back into a column major in the memory for future use, which would require store in scalar. Either method suffers from access orientation mismatch between data in a linear memory and the register file. Such operations may require many accesses (e.g., data loading or storing) to memory and general-purpose scalar registers and are inefficient in handling matrix operations.

Particular embodiments of this disclosure are directed to a two-dimensional (2D) ploy-morphic register file (PRF) that provides access in two dimensions (instead of the traditional 1D register file that can only be accessed row-by-row or column-by-column), with varying bit-width element support for variously data types. Such register file may be implemented for in-place matrix transformations, where the matrix data is transformed (e.g., mirrored, transposed, rotated, rows/cols inserted/removed) or through a pair of source and destination register files, to maintain the original copy in local CPU pipeline. The 2D register file may be disposed between the single cycle memory (SCM) and the execution unit of the CPU/DSP. The 2D registers file may include a number of registers. All registers in the 2D register file may be accessed during a single operation cycle (e.g., a reading cycle or a writing cycle). The system may first load the data from a memory (e.g., a single cycle memory) into the register file. The data stored in the memory and loaded into the register files may be arranged in a row-by-row order or column-by-column order. The system may determine a second order for the data based on the subsequent operations to process the data. Such operations may be scheduled to be executed by an execution unit of the CPU/DSP and may require the data to be transformed (e.g., matrix mirroring, transposing, rotating, rows/columns inserting, rows/columns removing) before being processed. The system may read the data from the register file according to the second order (by providing corresponding addresses) in a single operation cycle when the register file is configured to operate in a single cycle access mode (or in multiple operation cycles when the register file is configured to operate in a multiple cycle access mode). The data read from the register file may be arranged in the second order corresponding to a transformation (e.g., matrix mirroring, transposing, rotating, rows/columns inserting, rows/columns removing). In other words, the transformation needed to prepare the data for subsequent operations may be completed by reading the data from the register file according to the second order (with no need for separate transformation processes). The data arranged in the second order corresponding to the transformed data may be transmitted to the execution unit which is configured to execute the subsequent operations to process the transformed data.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example one-dimension registers that can be accessed row-by-row.

FIG. 2B illustrates an example register element.

FIG. 2A illustrates an example a poly-morphic 2D register file (2D PRF).

FIG. 3A illustrates an example process of using the 2D PRF 302 in the data processing pipeline of a CPU/DSP.

FIG. 3B illustrates an example process of reshaping data using 2D PRF.

FIGS. 4A-4D illustrate example transformations for an 8×8 array of 8-bit data.

FIG. 4E illustrates an example result of performing transpose on 4×4 array using the 8×8 data canvas.

FIG. 4F illustrates an example transformation of replacing a column to the array.

FIG. 4G illustrates an example result of the column replacement operation.

FIGS. 5A-5D illustrate example transformations of an 8×4 16-bit array.

FIGS. 6A-6B illustrate an example transformation of an 8×2 32-bit array.

FIG. 7 illustrates an example method of using 2D register file to transform data

FIG. 8 illustrates an example computer system.

### DESCRIPTION OF EXAMPLE EMBODIMENTS

A register file may be an array of registers in a central processing unit (CPU) or a digital signal processor (DSP). The register file may be implemented using SRAM, RAMs or other memory units with multiple ports. Such RAMs may have dedicated ports for reading and writing operations or may have shared ports for writing and writing operations. A register file may be used for specific operations such as floating points and stack operations, or for holding data and/or addresses. Registers may be auto indexed. For reading and writing operations, the system may provide the corresponding reading and writing addresses to the ports of the register file, which may either input or output the data based on the requested operations. A register file may use multiplexer in the input and/or output ports to pass data according the provided addresses.

Traditional CPUs or DSPs may have memory architectures that are weak on two-dimensional (2D) matrix handling, such as transposing, mirroring, rotating, inserting, and/or removing on matrices. CPU and Vector/SIMD (Single Instruction, Multiple Data) DSPs are good at accessing data in consecutive addressing order. For example, to perform computation on a transposed form of a 2D matrix, which is stored in row-major, the CPU or DSP either has to load them in column major through many single element (scalar) accesses or load them in vectors into vector registers (in vector/SIMD machines) and transform them back into a column major in the memory for future use, which would require store in scalar. Either method suffers from access orientation mismatch between data in a linear memory and the register file. Such operations may require many accesses (e.g., data loading or storing) to memory and general-purpose scalar registers and are inefficient in handling matrix operations.

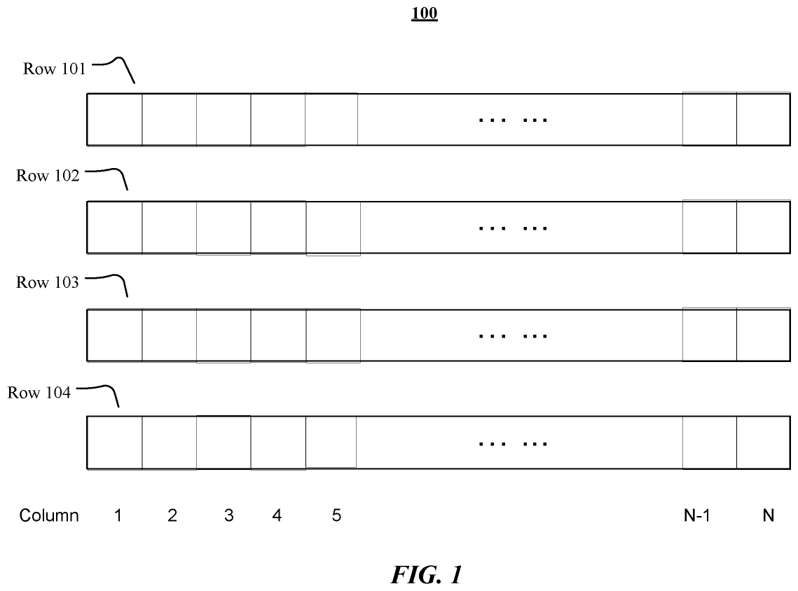

FIG. 1 illustrates an example one-dimension registers that can be accessed row-by-row. For example, as shown in FIG. 1, traditional memory and 1D register file may include a number of memory units (or register units) arranged in rows (e.g., 101, 102, 103, 104) and columns (e.g., columns 1 to N). Such traditional memory or 1D register file can only be accessed in particular manner (e.g., row-by-row, or column-by-column). In this example, the registers can only be accessed row-by-row. In other words, when the system accesses a row of the register, all the registers in that row are accessed during one access operation. If the system needs the data of a particular column, the system has to access the registers row-by-row with all registers being accessed and pick the data elements of that particular column (with other data discarded). Such operations could be very inefficient because they require many operation cycles and have a large portion of accessed data discarded. As a result, functions such as transposing, mirroring, rotating of matrices are done inefficiently by software. Such operations may involve loading data into multiple registers; repeated shuffling and selecting many cycles (e.g., many work registers); and storing them back to memory. This is a hidden cost of many 2D kernels (e.g., separable 2D FFT) and a bottleneck for the efficiencies of traditional CPUs and DSPs.

Particular embodiments of this disclosure are directed to a two-dimensional (2D) ploy-morphic register file (PRF) that provides access in two dimensions (instead of the traditional 1D register file that can only be accessed row-by-row or column-by-column), with varying bit-width element support for variously data types. In particular embodiments, such register file may be implemented for in-place matrix transformations, where the matrix data is transformed (e.g., mirrored, transposed, rotated, rows/cols inserted/removed) or through a pair of source and destination register files, to maintain the original copy in local CPU pipeline. Basically, if the next processing unit needs both original and transformed versions of the data, the separate source and destination register files may be used. If only the transformed version is needed, the in-place solution may be used. Since the size of the canvas may be fixed, the in-place transformation may provide higher dimensionality for possible transformations. The 2D register file may be disposed between the single cycle memory (SCM) and the execution unit of the CPU/DSP. The 2D registers file may include a number of registers. All registers in the 2D register file may be accessed during a single operation cycle (e.g., a reading cycle or a writing cycle). The system may first load the data from a memory (e.g., a single cycle memory (SCM)) into the register file. The data stored in the memory and loaded into the register files may be arranged in a row-by-row order or column-by-column order. The system may determine a second order for the data based on the subsequent operations to process the data. Such operations may be scheduled to be executed by an execution unit of the CPU/DSP and may require the data to be transformed (e.g., matrix mirroring, transposing, rotating, rows/columns inserting, rows/columns removing) before being processed. The system may read the data from the register file according to the second order (by providing corresponding addresses) in a single operation cycle when the register file is configured to operate in a single cycle access mode (or in multiple operation cycles when the register file is configured to operate in a multiple cycle access mode). The data read from the register file may be arranged in the second order corresponding to a transformation (e.g., matrix mirroring, transposing, rotating, rows/columns inserting, rows/columns removing). In other words, the transformation needed to prepare the data for subsequent operations may be completed by reading the data from the register file according to the second order (with no need for separate transformation processes). The data arranged in the second order corresponding to the transformed data may be transmitted to the execution unit which is configured to execute the subsequent operations to process the transformed data.

By using 2D register file between the single cycle memory (SCM) and the execution unit of the CPU/DSP, the CPU/DSP can complete the data transformation (e.g., matrix mirroring, transposing, rotating, rows/columns inserting, rows/columns removing) by accessing the 2D register file according to a special order (by providing the corresponding addresses). As such, the CPU/DSP may not need a separate transformation process to transform the data and can be more efficient by saving many operation cycles. Furthermore, by having 2D register file between the single cycle memory (SCM) and the execution unit of the CPU/DSP (rather than having all TCM memory as 2D memories, which would be extremely expensive), the CPU/DSP can significantly improve the efficiency and reduce the energy consumption without significantly increase the cost.

In particular embodiments, the 2D PRF structure may be realized by any storage technology that allows single cycle concurrent access to all register elements of the array. As such, the 2D PRF may be implemented with a flat SRAM array or 1 row, multi-port register files, or flat array of registers. In particular embodiments, the system may access all register elements or a subgroup of register element in the 2D PRF in a single operation cycle (e.g., a reading operation cycle or a writing operation cycle) when the 2D PRF is configured to operate in the single cycle access mode. In a single cycle access mode, all register elements in are accessed in one clock and selected and reordered for the new shape, based on the programmed configuration. In particular embodiments, the system may utilize multi-cycle access to the 2D PRF elements, trading-off performance and complexity of the storage element. In other words, the 2D PRF may be configured to operate in multi-cycle access mode and the system may access all or a subgroup of register elements in the 2D PRF in two or more operation cycles based on the trade-off results of the performance and complexity requirements. In the multi-cycle access mode, the system may allow sequence accesses to the PRF rows, one-after-another through a micro-code Finite-State-Machine. Such an implementation may need to add extra buffers to perform transformations in a sequential way, hiding the complexity from the software. In particular embodiments, the 2D PRF may be compatible with the traditional 1D access operations and may be configured to operate in 1D access mode. Under the 1D access mode, the register elements in the 2D PRF may be accessed row-by-row during one or more operation cycles as controlled by software and the execution unit.

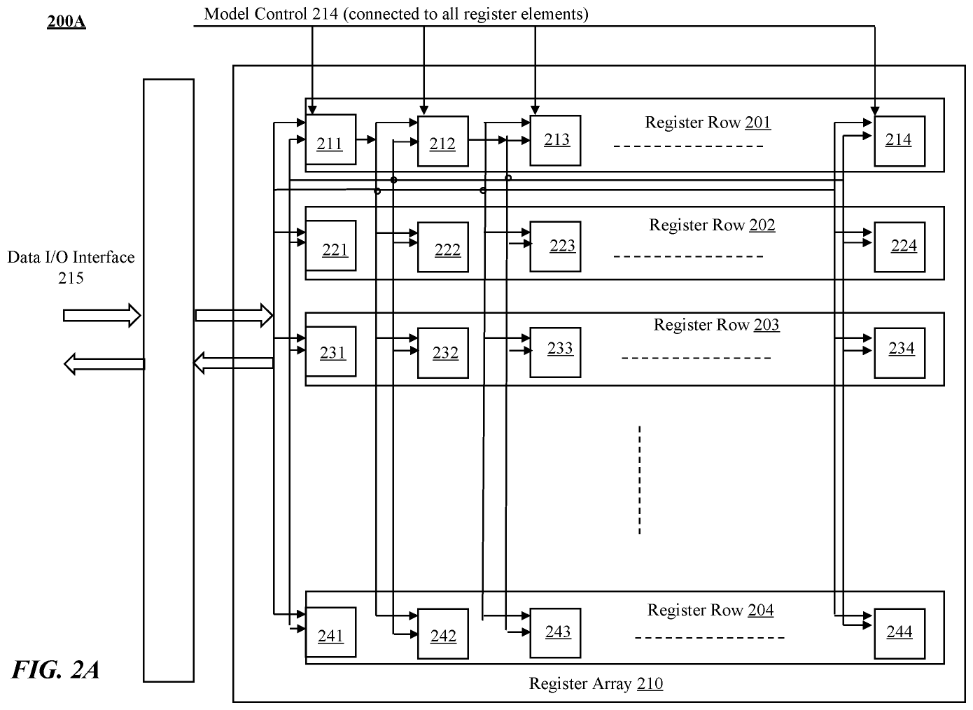

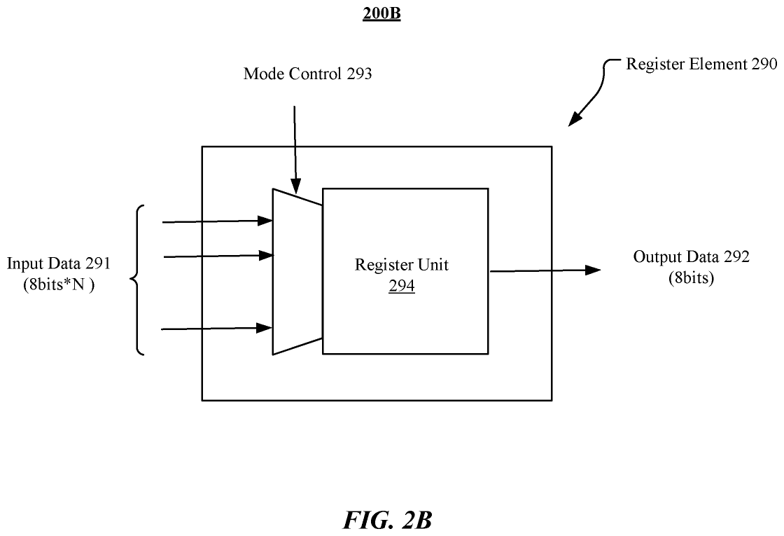

FIG. 2A illustrates an example a poly-morphic 2D register file (2D PRF) 200A. As an example and not by way of limitation, the 2D PRF 200A may include a register array 310 which includes a number of register element rows (e.g., 301, 302, 303, 304). Each register row may include a number of register elements. For example, the register rows 201, 202, 203, and 204 may include the register elements (211, 212, 213, 214), (221, 222, 223, 224), (231, 232, 233, 234), and (241, 242, 243, 244), respectively. All the register elements in the 2D register array 210 may be connected to the data I/O interface 215, which may have the bandwidth to allow all register elements in the register array 210 to be accessed during a single operation cycle. The I/O interface 215 may include a reading port to support reading operations and a writing port to support writing operations. During a reading or writing operation, the system may provide the register addresses to the data I/O interface 215 to read or write the data from the corresponding register elements. The addresses may be provided according to a particular order according to which the data is read out from the 2D PRF.

The mode control 214 may be connected to all register elements in the 2D PRF to control the access mode of the 2D PRF. The 2D PRF 200A may be configured to operate in a single cycle access mode. Under the single cycle access mode, all the register elements or a subgroup register elements of the 2D PRF 200A may be accessed during a single operation cycle (e.g., a writing operation cycle or a reading operation cycle). Alternatively, the 2D PRF 200A may be configured to operate in a multi-cycle access mode. Under the multi-cycle access mode, the system may allow sequence accesses to the PRF rows, one-after-another through a micro-code Finite-State-Machine. Such an implementation may need to add extra buffers to perform transformations in a sequential way, hiding the complexity from the software.

FIG. 2B illustrates an example register element 200B. As an example and not by way of limitation, the register element 200B may include a register unit 294 to store a unit data package. The register unit 294 may be an 8-bit data memory unit and may be connected to a data bus to receive the input data 291 through the data bus. The input data 291, which can be any data type that is supported by the 2D PRF, may correspond to N times of 8-bits data package. In other words, the input data, whatever data type it is, may be divided into unit data package of 8-bits, which can be stored in a register element. The register element 290 may be connected to the model control 293 to configure the mode under the register element may work. The register unit 294 may be connected to an output data bus to transmit the output data 292, which may be 8-bits data. The register file 200A may include a register array 210 which include a number of register elements arranged in rows and/or columns. However, it is notable, even the register elements are arranged in rows and/or columns, the register elements do not need to be accessed in row-by-row or column-by-column. All register elements or a selected subgroup of the register elements may be accessed concurrently during a single operation cycle according to an order specified by the addresses provided to the register file. In this disclosure, the term “register unit” may refer the memory unit of the register used to store the data (e.g., 8 bits). The term “register element” and “register” may refer to the register unit and the associated data ports (e.g., an input data port, an output data port, a model control port) and these two terms may be interchangeable. The “register element” may be used to refer to a “register” in the context of the register array to indicate that the register is a member element of that register array.

In particular embodiments, the 2D PRF may be configured to support a number of data types, including, for example, but not limited to 4-bit integer (INT4), 8-bit integer (INT8), 8-bit floating point, 16-bit integer (INT16), 16-bit brain floating point (BF16), 16-bit floating point (FP16), 32-bit integer (INT32), 32-bit floating point (FP32), etc. The supported data types may have a bit length that can be divided into 8-bit data packages, each of which can be stored in an 8-bit register element. A number with a particular data type may be stored in one or more register elements depending on the bit length of the number. The system may first determine the data type of the input data stored in the memory (to be loaded to the 2D PRF) and may configure the 2D PRF to receive that data with that particular data type before loading data into the registers.

In particular embodiments, the 2D PRF may have programmable data types, tile sizes, inserting rows, and operations. For example, the system may use a data canvas of 16×128 bits corresponding to all or a subgroup of the register elements in the 2D register file. By having the 16×128 bit data canvas, the system may be able to support manipulation of any of the following shapes as listed in Table 1:

TABLE 1

| | | |
|---|---|---|
| 8-bit data types | 16-bit data types | 32-bit data types |

| | | | | | |
|---|---|---|---|---|---|
| 16 × 16 | (8 bits) | 8 × 16 | (16 bits) | 4 × 16 | (32 bits) |
| 12 × 12 | (8 bits) | 8 × 8 | (16 bits) | 8 × 8 | (32 bits) |
| 9 × 9 | (8 bits) | 5 × 5 | (16 bits) | 5 × 5 | (32 bits) |

| | | | | |
|---|---|---|---|---|
| . . . | 16 × 8 | (16 bits) | 16 × 4 | (32 bits) |

| | | |
|---|---|---|
| . . . | 12 × 4 | (32 bits) |

. . .

In other words, the 16×128 bit data canvas may have a capacity to store 16×16×8 bits (i.e., 256×8 bits) of data. For data in 8-bit data type, any M×N array of 8-bit data may be hosted and processed within this data canvas 16×128 bits, as long as M≤16 and N≤16. For 16-bit data type, for which each single number may need two 8-bit registers, the 16×128 bit data canvas may be able to handle any M×N array of 16-bit data, as long as M*N≤128. For 32-bit data type, for which each single number may need four 8-bit registers, the 16×128 bit data canvas may be able to handle any M×N array of 16-bit data, as long as M*N≤64. As such, the 2D PRF may provide great flexibility which allows the system to process matrix with different sizes and/or different shapes using the same data canvas allocated in the register file. Upon receiving a request to process data in certain data type, matrix size, and matrix shape, the system may configure the register file regarding the data type and allocate a data canvas in the register file to hand the data in that data type, matrix size, and matrix shape. Upon receiving a new request to process new data in a different data type, matrix size, and matrix shape, the system may re-use the allocated data canvas in the register file as long as the new data falls within the canvas capacity range as described above. As such, the 2D PRF may provide significant flexibility and improved efficiency for CUPs/DSPs in processing different types of data with different matrix sizes and shapes.

In particular embodiments, a hierarchy of multiplexers may be needed with the width dictated by the minimum data-type bit width, thereby allowing reordering of the data to reflect the new shape. Storage into the second instance of the PRF, or in-place replacement, may also be done following the same model of single-cycle access. With this technique, the CPU/DSP may have a list of instructions getting added to the processor instruction set. The architecture may have three simple components with series of instructions defining the data movement between storage units. A first group of registers may be used as the source registers hosting external data from memory, queue, etc. A second group of register may be used for replacement data for column and row insertion. A third group of registers may be used as the destination registers for layout conversion. In particular embodiments, the width of the register may be equal to native vector register width of the architecture but the number of registers in the fabric should be divisible by number of elements of the target data type that register could accommodate. For example, for single precision floating point data type, the number of registers may be divisible by 4. Number of replacement registers may accommodate one row and one column of data for the largest fabric. The smallest unit in the canvas may be a byte. For the 2D representation of data types with N bytes, the system may need N registers to be able to fit at least one element column wise. In the in-place scenario, to be able to fit floats in each register, the row may be divisible by 4 but the system may also need at least 4 rows (registers) to be able to fit a float column wise.

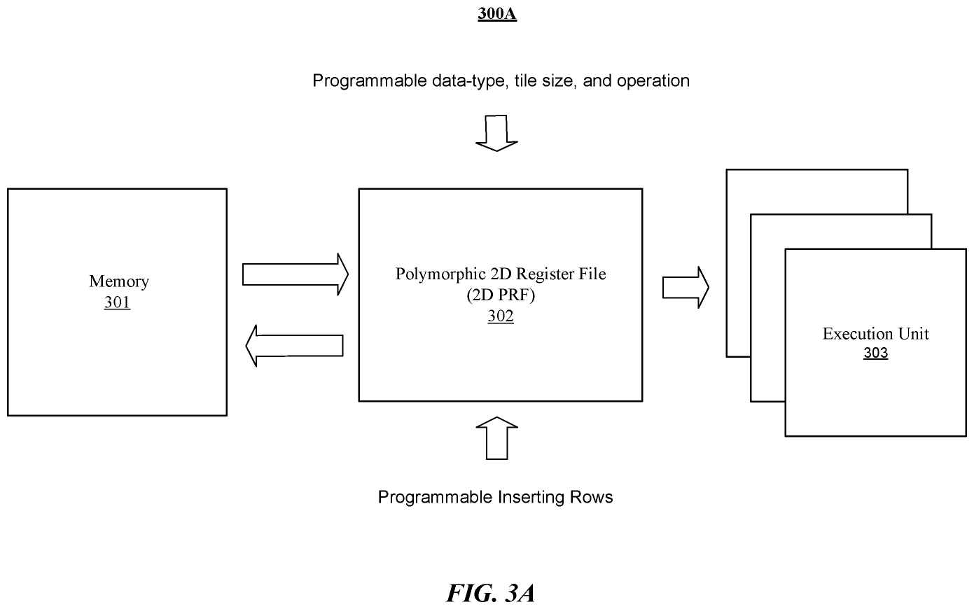

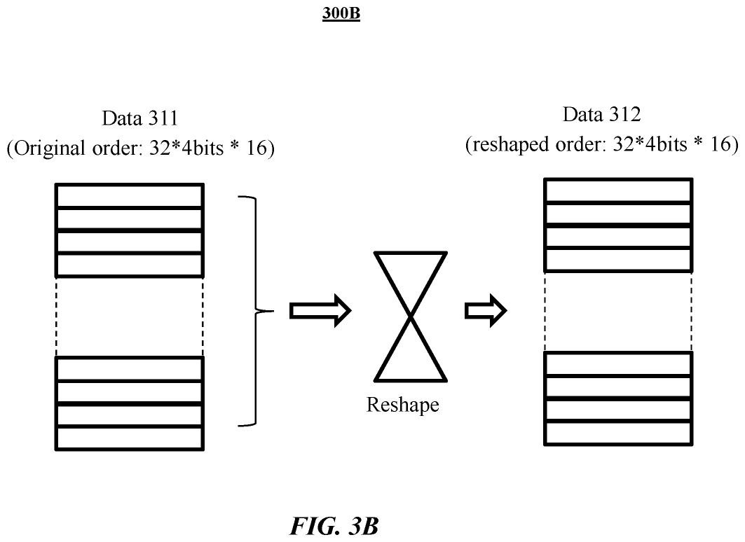

FIG. 3A illustrates an example process 300A of using the 2D PRF 302 in the data processing pipeline of a CPU/DSP. FIG. 3B illustrates an example process 300B of reshaping data using 2D PRF. As an example and not by way of limitation, the CPU/DSP may load data from memory 301 (e.g., data single cycle memory (SCM), data cache, or memory subsystem) to the 2D PRF 302. The data stored in the memory 301 may be arranged in a continuous order (e.g., a row-by-row order for a row-major matrix or column-by-column order for a column-major matrix). The data stored in the memory 301 may need to be transformed (e.g., row/column insertion, row/column removal, row/column replacement, transpose, mirror, rotation, etc.) for subsequent operations scheduled to use or process the data. The PRF instruction set may be used to configure the registers in the 2D PRF for the transformation operations (e.g., the data type of half-byte, byte, half-word, word, etc., the matrix size and shape) based on a determination on the transformation to be performed (e.g., row/column insertion, row/column removal, transpose, mirror, rotation, etc.). Then, the CPU/DSP may load the data from the memory 301 to the 2D PRF 302 according to the continuous order (e.g., a row-by-row order for a row-major matrix or column-by-column order for a column-major matrix). The data loaded into the 2D PRF 302 may be arranged in its original order. In other words, the data loaded into the 2D PRF 302 may be a mirror copy of the data in the memory 301.

Once the data loaded to the 2D PRF in the contiguous order, the 2D PRF may allow access to the data in-place in various re-shapes. In other words, the CPU/DSP may determine one or more subsequent operations that use or process the data stored in the 2D PRF and those operations may need the data to be transformed in particular manners (e.g., row/column insertion, row/column removal, transpose, mirror, rotation, etc.). The CUP/DSP may determine the reshaped order for the data based on the transformation operations needed, generate and provide the addresses to the access ports of the 2D PRF 302 to access (e.g., read or write) the registers (which stores the data 311) according to the reshaped order. The data 312 read from the 2D PRF 302 may be arranged in the reshaped order as a result of such reading process. As such, the data may be transformed to the target form (e.g., row/column insertion, row/column removal, transpose, mirror, rotation, etc.) as a natural result of the reading process and the CPU/DSP may not need a separate process to perform such transformations. After that, the CPU/DSP may pass the transformed data to the next execution unit(s) in the CPU pipeline or write the transformed data back in-place of the same PRF, another PRF module, a SIMD vector register file, a SIMD unit, a vector machine, etc., with the instructed re-shaped order. Alternatively, the DPS/CPU may store the transformed data in the re-shaped order directly back to the memory 301 for subsequent use.

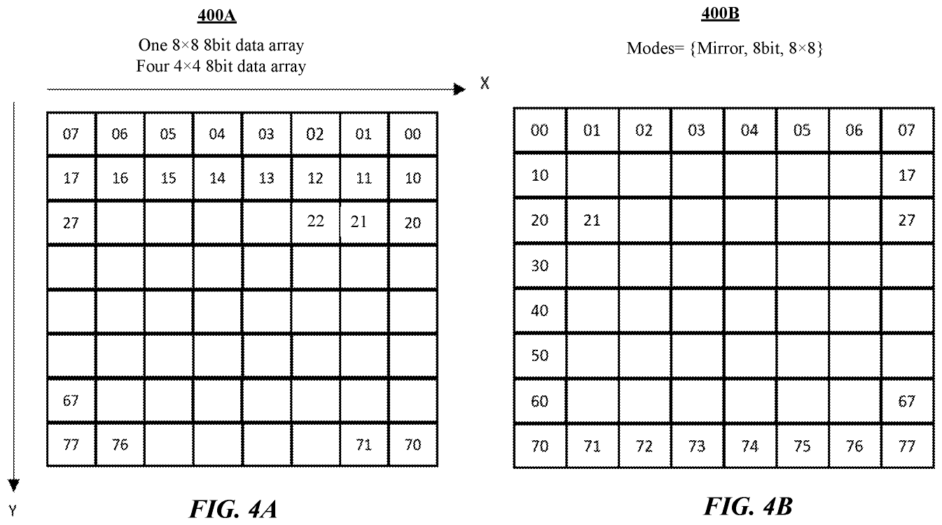

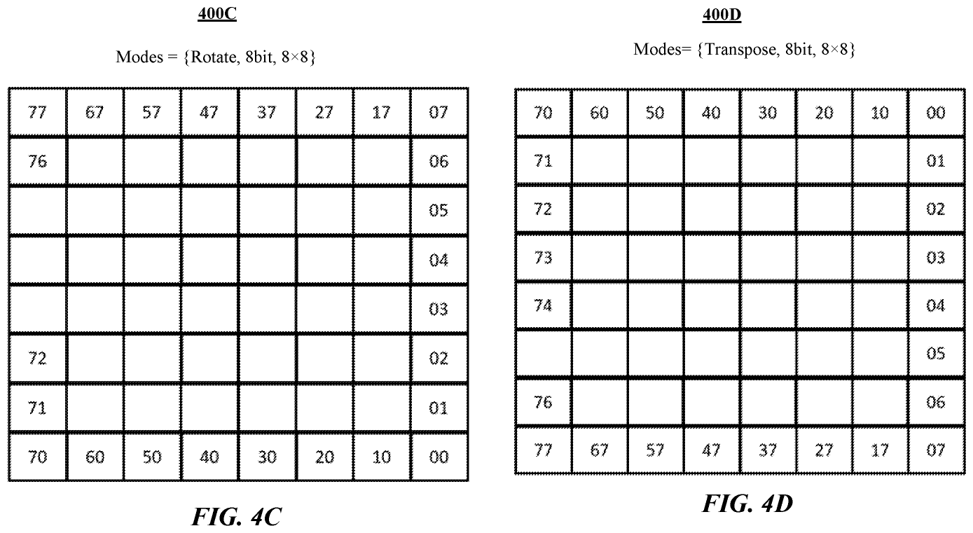

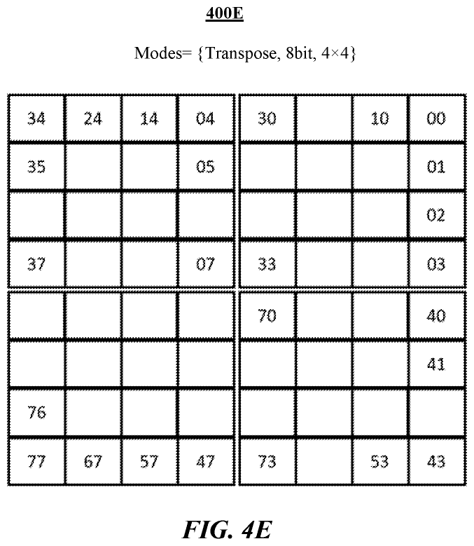

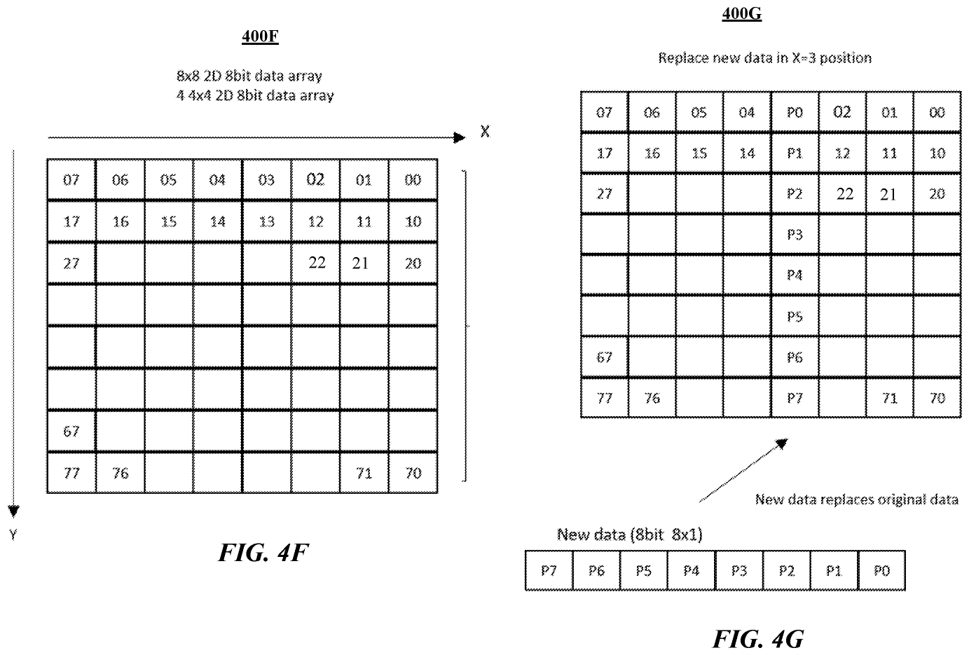

FIGS. 4A-4D illustrate example transformations for an 8×8 array of 8-bit data. As shown in FIG. 4A, the 8×8 array 400A may include 64 8-bit data, each of which ay correspond to a char, signed char, or FP8 data type. FIG. 4A shows the original array 400A before transformation. The array 400A may include the numbers (amongst other numbers in the array) as shown in the four corner areas of the array 400A. The array 400A may be initially stored in the single cycle memory (SCM). The CPU/DSP may allocate a data canvas in the register file that has a size equal to or larger than 8×8×8 bits to host the array. Then, the CPU/DSP may load the array 400A from the TCM to allocated data canvas of the 2D PRF. After that, the CPU/DSP may determine a reshaped order for the data based on the transformation to be performed (e.g., row/column insertion, row/column removal, transpose, mirror, rotation, etc.), generate the corresponding addresses, and provide the addresses to the 2D PRF. Then, the CPU/DSP may read the data in the 400A from the 2D PRF according the reshaped order. As a result, the array read from the 2D PRF may correspond to the transformed array with the reshaped order. FIG. 4B shows a resulting array 400B which is a mirror of the array 400A. FIG. 4C shows a resulting array 400C which is a rotation of the array 400A. FIG. 4D shows a resulting array 400D which is a transpose of the array 400A.

FIG. 4E illustrates an example result of performing transpose on 4×4 array using the 8×8 data canvas. As an example and not by way of limitation, the 8×8 data array as shown in FIG. 4A may be divided into four 4×4 sub-arrays. The CPU/DSP may directly transform all or any of the four 4×4 arrays by reading the data from the register file according to the transformed data order. The CPU/DSP may first determine the transformations. Then, the CPU/DSP may generate and provide the corresponding addresses with the reshaped order corresponding to the transformation to the register file. The output data may include the four 4×4 arrays corresponding to the transformed arrays. It is notable that the 4×4 sub-arrays described here are only for example purpose and the method, system, principle described in this disclosure are not limited thereto. By using the 2D PRF, the CPU/DSP may be capable to handle any sub-array falling within the allocated data canvas and the 2D register file may provide such flexibility and efficiency improvement.

FIG. 4F illustrates an example transformation of replacing a column to the array 400E. FIG. 4G illustrates an example result of the column replacement operation. The array 400F may be an 8×8 2D 8-bit data array which can be divided into four 4×4 2D 8-bit arrays. The new data (8-bit 8×1) may replace the original data in the X=3 position. The replacement result is shown in FIG. 4G. The systems, methods, and processes as described in this disclosure may support such column or row replacement operations.

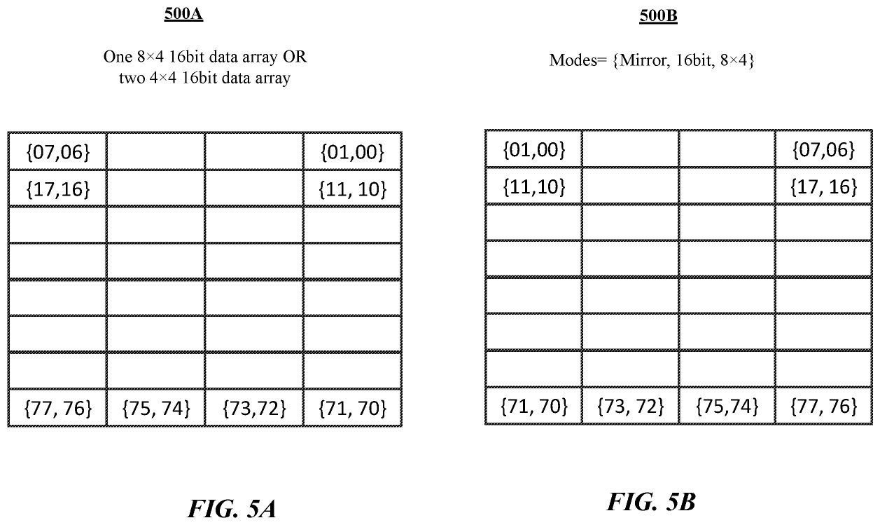

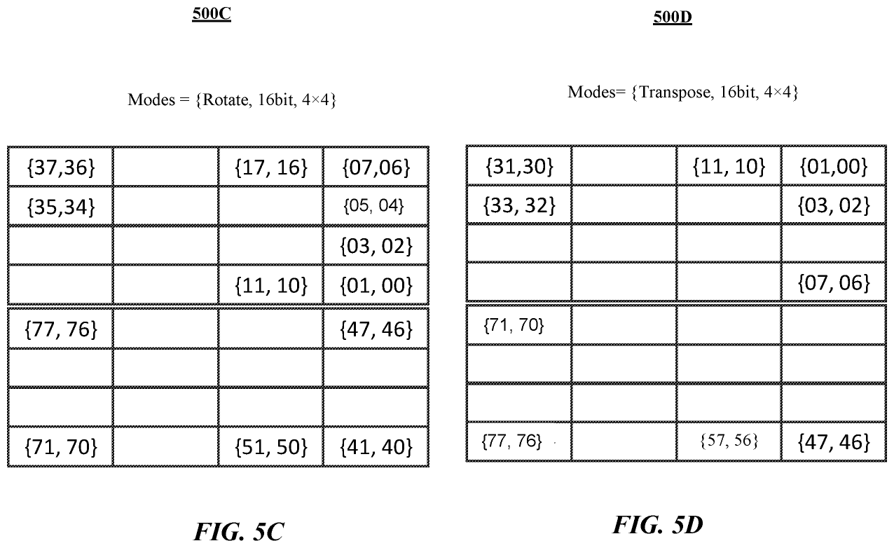

FIGS. 5A-5D illustrate example transformations of an 8×4 16-bit array. As shown in FIG. 5A, the original array 500A may include 8×4 16-bit data with each 16-bit data being stored in two 8-bit registers. It is notable that the 8×4 16-bit array may be handled in the same data canvas used for the 8×8 8-bit array, as shown in FIGS. 4A-4D. FIG. 5B shows a resulting array 500B corresponding to a mirrored array of the original 8×4 16-bit array 500A. For this transformation, each 16-bit data stored in two 8-bit registers may be still bundled together as one 16-bit data. The same 8×4 15-bit array 500A may be treated as two 4×4 16-bit arrays (e.g., the top half corresponding to the first 4×4 array, the bottom half corresponding to the second 4×4 array). These two 4×4 arrays may be processed concurrently using the same data canvas allocated in the register file. FIG. 5C and FIG. 5D show the resulting array 500C and 500D for the rotation and transpose of the two 4×4 16-bit array.

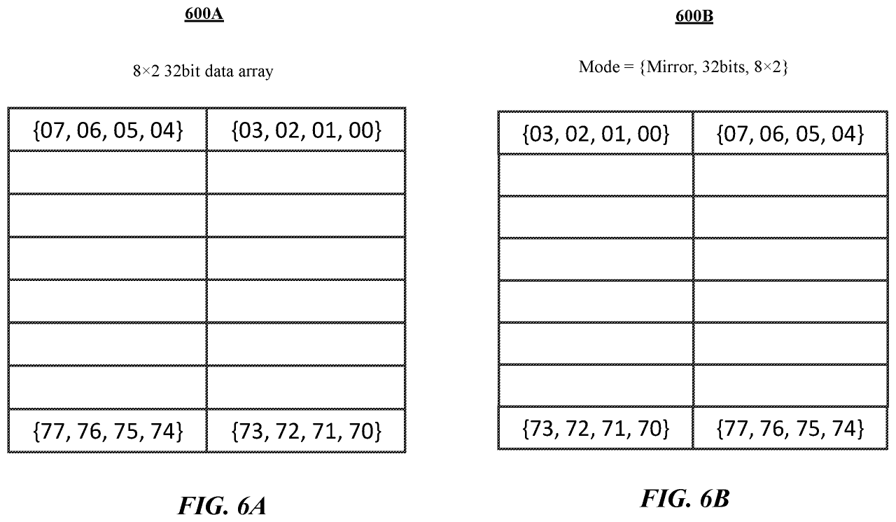

FIGS. 6A-6B illustrate an example transformation of an 8×2 32-bit array. FIG. 6A shows the original 8×2 32-bit array 600A, with each 32-bit data being stored in four 8-bit registers. It is notable that the 8×2 32-bit array 600A may be handled in the same data canvas used for the 8×8 8-bit array, as shown in FIGS. 4A-4D and used for the 8×4 16-bit array, as shown in FIGS. 5A-5B. FIG. 6B shows the resulting array 600B which corresponds to a mirror of the original array 600A. By using the 2D register file, the CPU/DSP may complete such transformation by accessing the register file with the reshaped order, without using a separate transformation process or operation.

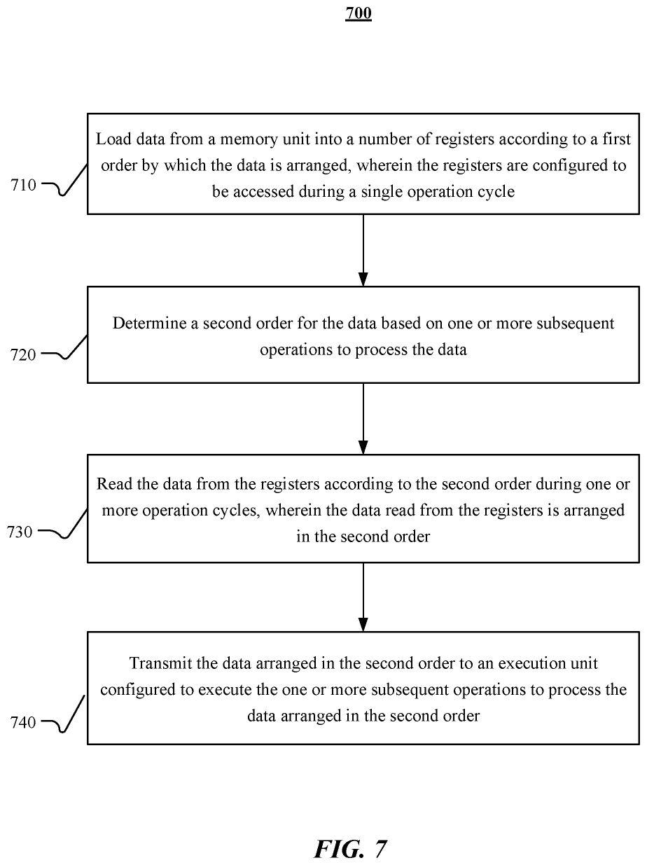

FIG. 7 illustrates an example method 700 of using 2D register file to transform data. The method may begin at step 710, where a computing system may load data from a memory unit into a plurality of registers according to a first order by which the data is arranged. The registers may be configured to be accessed during a single operation cycle. At step 720, the system may determine a second order for the data based on one or more subsequent operations to process the data. At step 730, the system may read the data from the plurality of registers according to the second order during one or more operation cycles. The data read from the plurality of registers may be arranged in the second order. At step 740, the system may transmit the data arranged in the second order to an execution unit configured to execute the one or more subsequent operations to process the data arranged in the second order.

In particular embodiments the plurality of registers may be within a register file disposed between the memory and the execution unit in a central processor unit. The memory may be a single cycle memory (SCM). In particular embodiments, the data loaded to the plurality may include a first array of numbers comprising a plurality of rows and columns. The first order may be a row-by-row order or column-by-column order. In particular embodiments, the data arranged in the second order may include a second array of number corresponding to a mirrored array, a transposed array, or a rotated array of the first array of numbers. In particular embodiments, the data arranged in the second order may include a fourth array of numbers excluding a row of numbers from the first array of numbers. In particular embodiments, the data arranged in the second order may include a third array of numbers comprising a new row of numbers with respect to the first array of numbers.

In particular embodiments, the system may configure a first sub-group of registers of the plurality of registers as source registers to store to store the data loaded from the memory, configure a second sub-group of registers of the plurality of registers as destination registers to store the data arranged in the second order, and configure a third sub-group of registers as replacement registers to store the new row of numbers. The new row of numbers may be inserted into third array numbers as a result of reading the data from the plurality of registers according to the second order. In particular embodiments, the system may load the data read from the plurality of registers according to the second order into the plurality of registers, the memory, or a plurality of second registers. In particular embodiments, the execution unit may include a vector machine or a single instruction multiple data (SIMD) unit.

In particular embodiments, the plurality of registers may be configured to host a plurality of data types comprising an integer data type with a first number of bits, and a float point data type with a second number bits. In particular embodiments, the one or more operation cycles to read the data from the plurality of registers may be determined based on a trade off between a performance requirement and a register file complexity requirement. In particular embodiments, the data may be read from the plurality of registers in one operation cycle in response to a determination that the plurality of registers are configured into a single cycle access mode.

In particular embodiments, each register of the plurality of registers may have a width equal to a native vector register width of the execution unit. In particular embodiments, the register number of the plurality of registers may be divisible by an element number of a target data type. In particular embodiments, the execution unit may be configured to execute a set of instructions to configure and access the plurality of the registers. In particular embodiments, determining a second order for the data based on one or more subsequent operations to process the data may include determining a plurality of addresses for the plurality of registers according to the one or more subsequent operations. In particular embodiments, reading the data from the plurality of registers may include providing the plurality of addresses to an access interface associated with the plurality of registers, and wherein the access interface is configured to have a bandwidth to read or write the plurality of register in a single operation cycle. In particular embodiments, the plurality of registers may be configured to support a row by row accessing operation.

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for using 2D register file to transform data including the particular steps of the method of FIG. 7, this disclosure contemplates any suitable method of using 2D register file to transform data including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

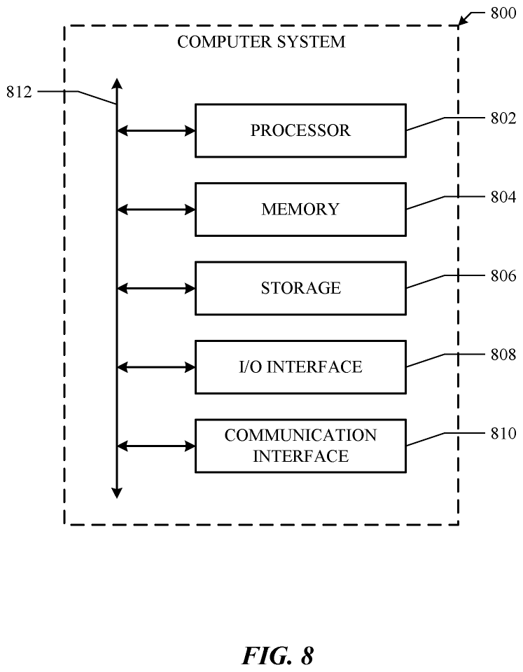

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
loading data from a memory unit into a plurality of registers according to a first order by which the data is arranged, wherein the plurality of registers are configured to be accessed during a single operation cycle;
determining a second order for the data based on one or more subsequent operations to process the data;
reading the data from the plurality of registers according to the second order during one or more operation cycles, wherein the data read from the plurality of registers is arranged in the second order; and
transmitting the data arranged in the second order to an execution unit configured to execute the one or more subsequent operations to process the data arranged in the second order.

2. The method of claim 1, wherein the plurality of registers are within a register file disposed between the memory and the execution unit in a central processor unit, and wherein the memory is a single cycle memory (SCM).

3. The method of claim 1, wherein the data loaded to the plurality comprises a first array of numbers comprising a plurality of rows and columns, and wherein the first order is a row-by-row order or column-by-column order.

4. The method of claim 3, wherein the data arranged in the second order comprises a second array of number corresponding to a mirrored array, a transposed array, or a rotated array of the first array of numbers.

5. The method of claim 3, wherein the data arranged in the second order comprises a fourth array of numbers excluding a row of numbers from the first array of numbers.

6. The method of claim 3, wherein the data arranged in the second order comprises a third array of numbers comprising a new row of numbers with respect to the first array of numbers.

7. The method of claim 7, further comprising:
configuring a first sub-group of registers of the plurality of registers as source registers to store to store the data loaded from the memory;
configuring a second sub-group of registers of the plurality of registers as destination registers to store the data arranged in the second order; and
configuring a third sub-group of registers as replacement registers to store the new row of numbers, wherein the new row of numbers are inserted into third array numbers as a result of reading the data from the plurality of registers according to the second order.

8. The method of claim 1, further comprising:
loading the data read from the plurality of registers according to the second order into the plurality of registers, the memory, or a plurality of second registers.

9. The method of claim 1, wherein the execution unit comprises a vector machine or a single instruction multiple data (SIMD) unit.

10. The method of claim 1, wherein the plurality of registers are configured to host a plurality of data types comprising an integer data type with a first number of bits, and a float point data type with a second number bits.

11. The method of claim 1, wherein the one or more operation cycles to read the data from the plurality of registers are determined based on a trade off between a performance requirement and a register file complexity requirement.

12. The method of claim 1, wherein the data is read from the plurality of registers in one operation cycle in response to a determination that the plurality of registers are configured into a single cycle access mode.

13. The method of claim 1, wherein each register of the plurality of registers has a width equal to a native vector register width of the execution unit.

14. The method of claim 1, wherein a register number of the plurality of registers is divisible by an element number of a target data type.

15. The method of claim 1, wherein the execution unit is configured to execute a set of instructions to configure and access the plurality of the registers.

16. The method of claim 1, wherein determining a second order for the data based on one or more subsequent operations to process the data comprises determining a plurality of addresses for the plurality of registers according to the one or more subsequent operations.

17. The method of claim 16, wherein reading the data from the plurality of registers comprises providing the plurality of addresses to an access interface associated with the plurality of registers, and wherein the access interface is configured to have a bandwidth to read or write the plurality of register in a single operation cycle.

18. The method of claim 1, wherein the plurality of registers are configured to support a row by row accessing operation.

19. One or more computer-readable non-transitory storage media embodying software that is operable when executed to:
load data from a memory unit into a plurality of registers according to a first order by which the data is arranged, wherein the plurality of registers are configured to be accessed during a single operation cycle;
determine a second order for the data based on one or more subsequent operations to process the data;
read the data from the plurality of registers according to the second order during one or more operation cycles, wherein the data read from the plurality of registers is arranged in the second order; and
transmit the data arranged in the second order to an execution unit configured to execute the one or more subsequent operations to process the data arranged in the second order.

20. A system comprising:
one or more non-transitory computer-readable storage media embodying instructions; and
one or more processors coupled to the storage media and operable to execute the instructions to:
load data from a memory unit into a plurality of registers according to a first order by which the data is arranged, wherein the plurality of registers are configured to be accessed during a single operation cycle;
determine a second order for the data based on one or more subsequent operations to process the data;
read the data from the plurality of registers according to the second order during one or more operation cycles, wherein the data read from the plurality of registers is arranged in the second order; and
transmit the data arranged in the second order to an execution unit configured to execute the one or more subsequent operations to process the data arranged in the second order.
